(19) United States
(12) Patent Application Publication
(10) Pub. No.: US 2003/0029385 A1
(43) Pub. Date: Feb. 13, 2003

(54) Method of and a device for cleaning the teats and/or the udder of a dairy animal, a method of and a device for milking an animal

(75) Inventor: Ranatus Ignatius Josephus Fransen, Vlaardingen (NL)

Correspondence Address: Penrose Lucas Albright, Esq., MASON, MASON & ALBRIGHT, P.O. Box 2246, Arlington, VA, 22202-0246, US

(73) Assignee: LELY LELY ENTERPRISES AG

(21) Appl. No.: 10/212,161

(22) Filed: Aug. 6, 2002

(30) Foreign Application Priority Data
Aug. 7, 2001 (NL) 1018723

(51) Int. Cl. A01J 3/00; A01J 5/00

(52) U.S. Cl. 119/14.02

(57) ABSTRACT

A method of cleaning the teats and/or the udder of a dairy animal. The method comprises a cleaning step of applying a cleaning fluid on the teats and/or the udder. The method comprises prior to the cleaning step a soaking step of applying a soaking fluid on the teats and/or the udder. A device for cleaning the teats and/or the udder of a dairy animal. The device comprises a cleaning device for applying a cleaning fluid on the teats and/or the udder. The device is provided with a soaking device for applying a soaking fluid on the teats and/or the udder. The device preferably comprises a mobile device. A method of milking a dairy animal, the method comprising a step of stimulating the teats and/or the udder of the dairy animal. The method comprises an application step of applying a fluid on the teats and/or the udder. A device for milking a dairy animal, the device being provided with a stimulation device for stimulating the teats and/or the udder of the dairy animal. The stimulation device comprises an application device for applying a fluid on the teats and/or the udder, the application device being provided with a reservoir for a stimulation fluid or with a connection device for connection with a reservoir for stimulation fluid.

The invention relates to a method of cleaning the teats and/or the udder of a dairy animal according to the preamble of claim 1.

The invention also relates to a device for cleaning the teats and/or the udder of a dairy animal according to the preamble of claim 14.

The invention further relates to a method of milking a dairy animal according to the preamble of claim 31.

The invention further relates to a device for milking a dairy animal according to the preamble of claim 38.

Such a method and device for cleaning the teats and/or the udder are known. However, it has appeared that in particular when the teats and/or the udder are highly contaminated, the performed cleaning does not always result in sufficiently clean teats and/or udder.

It is an object of the invention to provide a method of and a device for cleaning the teats and/or the udder of a dairy animal by means of which a sufficient cleaning of the teats and/or the udder can be obtained.

According to a first aspect of the invention, for that purpose a method of the above-described type comprises the measures of the characterizing part of claim 1. Due to the fact that, prior to the cleaning step, a soaking fluid is applied on the teats and/or the udder, this soaking fluid can soften dirt present on the teats and/or the udder, especially caked dirt, so that the cleaning step succeeding the soaking step can remove also this dirt from the teats and/or the udder in a simple manner. For the soaking fluid the usual liquids such as water, with possibly a particular soap, shampoo or the like added thereto, may be used.

Although the soaking fluid may be applied with the aid of brushes, cloths or the like, it is preferred for the sake of simplicity when the step of applying a soaking fluid comprises the spraying of soaking fluid.

The method preferably comprises an identification step of identifying an animal. In this manner it may be determined for example which animal has already been subjected to a soaking step.

When the method comprises a designation step of designating an animal whose teats and/or udder have to be soaked, the soaking step can be applied very specifically. For example an animal whose teats and/or udder have to be cleaned within a predetermined time may be designated as an animal which has to be subjected to the soaking step.

In this situation it is advantageous when the designation step comprises a location indicating step of indicating the location of a designated animal, so that the animal whose teats and/or udder have to be treated with soaking fluid can be found quickly and efficiently.

Although the soaking step may be carried out manually or by a machine arranged at a fixed place, it is preferred when the soaking step is carried out by a mobile device for applying a soaking fluid, the mobile device being provided with a reservoir for soaking fluid or with a connection device for connection with a reservoir for soaking fluid. Thus the animals need not to be disturbed in their activities, and the soaking step can be carried out at any place in the stable or in the meadow.

An embodiment of a method according to the invention comprises a control step of controlling the mobile device to the location of a designated animal.

For the purpose of obtaining a reliable soaking step, and thus obtaining a sufficiently efficient cleaning, the method comprises a checking step of checking whether soaking fluid has been applied on the teats and/or the udder of an animal.

Although the animals may be taught, by the so-called Pavlov effect as a result of applying the soaking fluid, to go to a predetermined place, it is advantageous when the method comprises after the soaking step a guiding step of guiding the animal subjected to the soaking step to the predetermined place.

In an advantageous manner as a predetermined place a milking parlour for milking an animal is chosen. It is customary when prior to the milking a cleaning step is carried out in the milking parlour. Alternatively a pre-selection box may be chosen as a predetermined place.

However, in some cases it may be desirable to choose a cleaning parlour for cleaning the teats and/or the udder as a predetermined place. For example when an animal has an udder inflammation, for the sake of preventing infection it is recommended to guide the animal to a cleaning parlour which is located at some distance from a milking parlour.

The guiding step is preferably carried out by a mobile device provided with a seizing device for seizing an animal.

According to a second aspect of the invention, for that purpose a device of the above-described type comprises the measures of the characterizing part of claim 14. The soaking device preferably comprises a sprayer for spraying a soaking fluid. In an embodiment the device is provided with a reservoir for a soaking fluid or with a connection device for connection with a reservoir for soaking fluid.

An embodiment of a device according to the invention is characterized in that the device is provided with an identification system for identifying an animal, the identification system being provided with a computer having a memory. In particular the memory is suitable for storing data in relation to the points of time when the teats and/or the udders of animals have been soaked and in relation to the identity of the relevant animals.

A further embodiment of a device according to the invention is characterized in that the computer is suitable for determining, on the basis of historical data in the memory, the animal whose teats and/or udder have to be soaked first. In particular when the teats and/or the udder have to be soaked a certain number of times per day, said determination is advantageous. The memory may then be used in an advantageous manner for also storing the points of time of cleaning of the teats and/or the udder, and for using these data together with the historical data in relation to the soaking steps for determining the animal whose teats and/or udder have to be subjected to a soaking step first. Thus it is possible for example to designate the animal whose teats and/or udder have to be cleaned over a predetermined period of time, so that the soaking fluid has sufficient time to soak the dirt on the teats and/or the udder.

For the purpose of having performed an automatic milking process efficiently, it is preferred when the computer is also suitable for determining dairy animal data in relation to the sequence of animals to be milked, the dairy animal data being used together with the historical data in the memory for determining the animal whose teats and/or udder have to be soaked first.

The device preferably comprises a location indicating means for indicating the location of the animal whose teats and/or udder have to be soaked first. Such a location indicating means is known per se, e.g. from Dutch patent application NL-A-1000969.

Although the soaking device may be disposed at a fixed place, it is advantageous when the device is provided with a mobile device for applying a soaking fluid on the teats and/or the udder. The device preferably comprises a transmitting means for transmitting location data to the mobile device, the mobile device being provided with a receiver device for receiving the location data. For enabling to determine the position of the mobile device the latter is provided with a position determining means.

For the purpose of checking whether soaking fluid has actually been applied on the teats and/or the udder, an embodiment of a device according to the invention is provided with a checking means for checking whether soaking fluid has been applied on the teats and/or the udder of an animal. The checking means preferably comprises a camera, in particular an infrared camera. It is then advantageous when the checking means is disposed on a telescopic carrier.

For the purpose of guiding the animal to a predetermined place after its teats and/or udder have been soaked, the mobile device comprises a guide means for guiding an animal subjected to the soaking step to a predetermined place. In particular the guide means is provided with a seizing device for seizing an animal, or with a component fastened to the animal, such as a belt, collar or the like.

The invention is further based on the insight that, when instead of a soaking fluid a stimulation fluid is used, a dairy animal can be stimulated to producing milk. It is noticed that stimulation by e.g. massaging the teats and/or the udder is known.

Thus the invention relates in a third aspect to a method of milking a dairy animal, the method comprising the step of stimulating the teats and/or the udder of the dairy animal, characterized in that the stimulation step comprises an application step of applying a stimulation fluid on the teats and/or the udder. Advantageous embodiments of the method according to this fourth aspect of the invention appear from the subclaims.

In a fourth aspect the invention further relates to a device for milking a dairy animal, said device being provided with a stimulation device for stimulating the teats and/or the udder of the dairy animal, characterized in that the stimulation device comprises an application device for applying a fluid on the teats and/or the udder, the application device being provided with a reservoir for a stimulation fluid or with a connection device for connection with a reservoir for stimulation fluid. Advantageous embodiments of the device according to this third aspect of the invention appear from the subclaims.

The invention will now be explained in further detail with reference to the accompanying figures, in which:

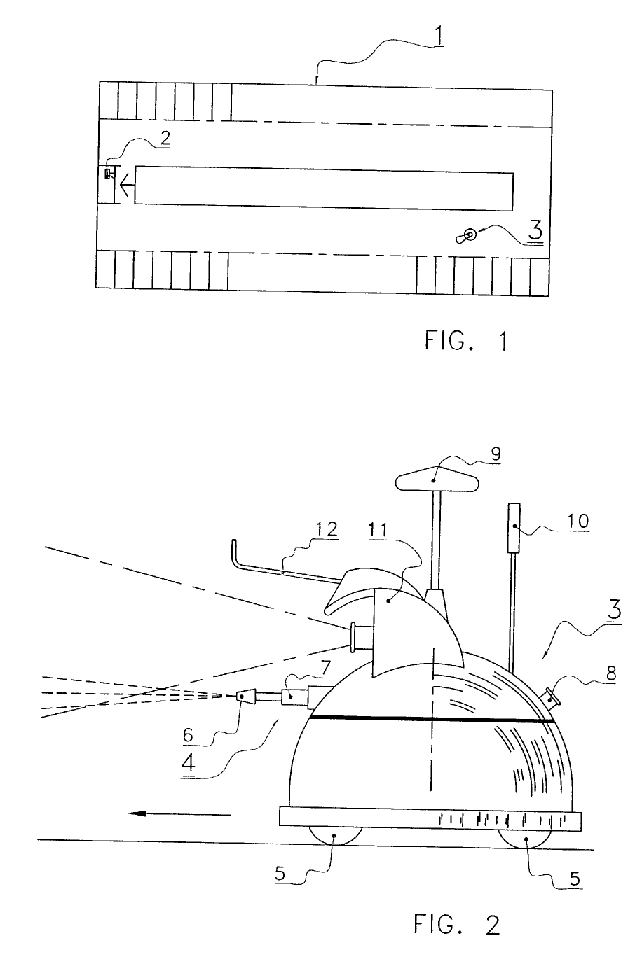

FIG. 1 is a plan view of a stable with a mobile device disposed therein for applying a soaking fluid on the teats and/or the udder of an animal;

FIG. 2 is a side view of a mobile device according to FIG. 1.

The invention will be described hereinafter by way of example with reference to a mobile device provided with a soaking device. However, it will be obvious that the invention also relates to a device provided with a soaking device disposed at a fixed place. The invention is further described with reference to a milking robot as a predetermined place to which a dairy animal, in particular a cow, is guided after its teats and/or udder have been provided with a soaking fluid. However, it will be obvious that as a predetermined place a pre-selection box, a separate cleaning parlour or the like may function as well. The invention will also be described with reference to a soaking fluid which is applied on the teats and/or the udder of the animal. However, it will be obvious that the invention also relates to the application of a stimulation fluid instead of a soaking fluid, prior to milking a dairy animal.

FIG. 1 is a plan view of a stable 1 provided with a milking robot 2 for automatically milking animals and a mobile device 3, e.g. an unmanned vehicle, provided with a soaking device 4 (FIG. 2) for applying a soaking fluid on the teats and/or the udder of an animal, e.g. a cow.

FIG. 2 is a side view of the unmanned vehicle 3 which is provided with wheels 5. The wheels 5 are driven by a (non-shown) driving unit, such as an electric motor.

In the present embodiment the soaking device 4 of the unmanned vehicle comprises a sprayer 6 disposed e.g. on a telescopic carrier 7. The sprayer 6 is connected with a container (non-shown in FIG. 2) for containing soaking fluid, said container being located in the unmanned vehicle 3. The unmanned vehicle 3 is also provided with a filling connection 8, or another connection device, by means of which the container in the unmanned vehicle 3 may be connected with an external source of soaking fluid. Further means for determining the position of the teats and/or the udder of an animal are not further described since these belong to the state of the art, e.g. the position determining means as used with milking robots for connecting the teat cups to the teats.

The milking robot 2 comprises in a manner known per se an identification system for identifying an animal, the identification system being provided with a computer having a memory. On the basis of the data present in such a memory in relation to the milking of a cow, the computer is able to determine the sequence in which cows have to be milked. Due to this, the computer can indicate a sequence of which cows should be milked consecutively. It being customary to clean, prior to milking, the teats and/or the udder, at least the teats thereof, the milking sequence may also be used to designate those cows whose teats and/or udder have to be treated with soaking fluid.

As disclosed in Dutch patent application NL-A-1000969, the location of these cows may be indicated, so that the inventive device preferably comprises such a known location indicating means for indicating the location of the animal whose teats and/or udder have to be soaked first.

The mobile device 3 is provided with a position determining means 9, which may be constituted by a radar, a GPS-system component or the like. This makes it possible to determine the momentary place of the mobile device 3. For the purpose of moving quickly to the location of a dairy animal, whose teats and/or udder have to be treated with soaking fluid, the computer comprises a (non-shown) transmitter device, or a transmitter device for transmitting location data to the mobile device. The mobile device 3 is provided with a receiver device 10 for receiving the location data, said data being used for (roughly) controlling the mobile device 3 to the location. A further description of the control of the mobile device is omitted here for the sake of simplicity, the more as self-propelled mobile devices are known per se in the state of the art.

When the mobile device 3 has arrived at the location of a cow whose teats and/or udder have to be treated with soaking fluid, the mobile device 3 first has to verify where the teats and/or the udder are located. In the embodiment shown, for that purpose the mobile device 3 is provided with accurate teat determining means 11 in the form of picture recognition equipment. This picture recognition equipment may also be used for verifying whether a cow is standing or lying. If it appears that a cow is lying, it is possible to stimulate the cow e.g. by means of a stimulation device 12 to stand up, so that the teats and/or the udder become accessible to treatment.

When the position of the teats and/or the udder has been determined, the sprayer 6 may be directed to the teats and/or the udder and be put into operation. Directing the sprayer may take place by correct operation of the wheels 5 or by directing the sprayer 6.

The picture recognition equipment 11 may also be used to check whether soaking fluid has been applied on the teats and/or the udder of the cow. If it appears that no or not sufficient soaking fluid has been applied, a signal may be issued so that the sprayer is put into operation again. Besides a camera for picture recognition an infrared camera may be used as well as a checking means. For the purpose of bringing the checking means close to the teats and/or the udder, said means is preferably disposed on a telescopic carrier (non-shown in the figures).

Although not shown in the figures, the mobile device 3 comprises an animal identification system for recognising the animal whose teats and/or udder have to be treated or have been treated with soaking fluid.

When the points of time when the teats and/or the udders of animals have been soaked and the identity of the relevant animals are stored in a memory, these historical data may be used partially for determining the point of time when the next soaking step with a certain animal has to be carried out. These data may also be used for determining of which animal the teats and/or the udder have to be soaked first. The animal identification system may also be used for applying a soaking fluid in dependence of the animal. For that purpose the mobile device 3 is then provided with various soaking fluid containers.

The soaking fluid may be constituted by a fluid known per se, such as water possibly with soap, shampoo or the like as an additive. Further it may be ensured by training or conditioning that a dairy animal, after the soaking fluid has been applied, automatically goes to a certain place, such as the milking robot in the embodiment shown. For the purpose of facilitating that an animal observes that soaking fluid has been applied on its teats and/or, udder, additives may be added, such as alcohol (causing cooling of the teats and/or the udder by evaporation), or an additive causing on the contrary heating or tingling of the skin. Such additives appear to be highly suitable for serving as a stimulation fluid, of course in dependence of the concentration and the individual animal.

Additionally or alternatively to an animal automatically going to a predetermined place, the mobile device 3 may comprise a guide means for guiding an animal subjected to the soaking step to a predetermined place. Such a guide means may be constituted by a driving means (see NL-A-1000969) or a seizing device for seizing an animal, or an element disposed on the animal, such as a collar or the like.

Although in the above described embodiment the computer of the identification system belonging to the milking robot is used for controlling the mobile device and controlling the soaking, it will be obvious that a separate computer, adapted to the purpose, may be used as well.

In relation to the device and the method of stimulating the teats and/or the udder of an animal, it is preferred when this takes place in the pre-selection box, disposed in front of the milking box. It is then advantageous when the stimulation fluid is applied maximally approximately 1 minute before the animal enters the milking box. Thus is advantageous to apply the stimulation fluid at a moment when the animal leaves the pre-selection box. This may take place in an advantageous manner by disposing the application device in the vicinity of the exit of the pre-selection box. Near this exit there is provided an animal identification determining at least approximately the point of time when the relevant animal leaves the pre-selection box. When the animal identification detects the presence of the animal in or near the exit, it issues a relevant signal controlling the application device so that the latter produces stimulation fluid. It will be obvious that also other presence detectors, such as cameras, may be used for determining approximately the point of time of leaving the pre-selection box.

1. A method of cleaning the teats and/or the udder of a dairy animal, the method comprising a cleaning step of applying a cleaning fluid on the teats and/or the udder, characterized in that the method comprises, prior to the cleaning step, a soaking step of applying a soaking fluid on the teats and/or the udder.

2. A method as claimed in claim 1, characterized in that the step of applying a soaking fluid comprises the spraying of soaking fluid.

3. A method as claimed in claim 1 or 2, characterized in that the method comprises an identification step of identifying an animal.

4. A method as claimed in any one of the preceding claims, characterized in that the method comprises a designation step of designating an animal whose teats and/or udder have to be soaked.

5. A method as claimed in claim 4, characterized in that the indicating step comprises a location indicating step of indicating the location of a designated animal.

6. A method as claimed in claim 1, 2 or 3, characterized in that the soaking step is carried out by a mobile device for applying a soaking fluid, the mobile device being provided with a reservoir for soaking fluid or with a connection device for connection with a reservoir for soaking fluid.

7. A method as claimed in claims 5 and 6, characterized in that the method comprises a control step of controlling the mobile device to the location of a designated animal.

8. A method as claimed in any one of the preceding claims, characterized in that the method comprises a checking step of checking whether soaking fluid has been applied on the teats and/or the udder of an animal.

9. A method as claimed in any one of the preceding claims, characterized in that the method comprises after the soaking step a guiding step of guiding the animal subjected to the soaking step to a predetermined place.

10. A method as claimed in claim 9, characterized in that as a predetermined place a milking parlour for milking an animal is chosen.

11. A method as claimed in claim 9, characterized in that as a predetermined place a cleaning parlour for cleaning the teats and/or the udder is chosen.

12. A method as claimed in claim 9, characterized in that as a predetermined place a pre-selection box is chosen.

13. A method as claimed in any one of the preceding claims 9 through 12, characterized in that the guiding step is carried out by a mobile device provided with a seizing device for seizing an animal.

14. A device for cleaning the teats and/or the udder of a dairy animal, the device comprising a cleaning device for applying a cleaning fluid on the teats and/or the udder, characterized in that the device is provided with a soaking device for applying a soaking fluid on the teats and/or the udder.

15. A device as claimed in claim 14, characterized in that the soaking device comprises a sprayer for spraying a soaking fluid.

16. A device as claimed in claim 14 or 15, characterized in that the device is provided with a reservoir for a soaking fluid or with a connection device for connection with a reservoir for soaking fluid.

17. A device as claimed in any one of the preceding claims 14 through 16, characterized in that the device is provided with an identification system for identifying an animal, the identification system being provided with a computer having a memory.

18. A device as claimed in claim 17, characterized in that the memory is suitable for storing data in relation to the points of time when the teats and/or the udders of animals have been soaked and in relation to the identity of the relevant animals.

19. A device as claimed in claim 18, characterized in that the computer is suitable for determining, on the basis of historical data in the memory, the animal whose teats and/or udder have to be soaked first.

20. A device as claimed in claim 19, characterized in that the computer is also suitable for determining dairy animal data in relation to the sequence of animals to be milked, the dairy animal data being used together with the historical data in the memory for determining the animal whose teats and/or udder have to be soaked first.

21. A device as claimed in claim 19 or 20, characterized in that the device comprises a location indicating means for indicating the location of the animal whose teats and/or udder have to be soaked first.

22. A device as claimed in any one of the preceding claims 14 through 21, characterized in that the device is provided with a mobile device for applying a soaking fluid on the teats and/or the udder.

23. A device as claimed in claim 22, characterized in that the device comprises a transmitting means for transmitting location data to the mobile device, the mobile device being provided with a receiver device for receiving the location data.

24. A device as claimed in claim 22 or 23, characterized in that the mobile device is provided with a position determining means.

25. A device as claimed in any one of the preceding claims 14 through 24, characterized in that the device is provided with a checking means for checking whether soaking fluid has been applied on the teats and/or the udder of an animal.

26. A device as claimed in claim 25, characterized in that the checking means comprises a camera.

27. A device as claimed in claim 26, characterized in that the camera is constituted by an infrared camera.

28. A device as claimed in claim 25, 26 or 27, characterized in that the checking means is disposed on a telescopic carrier.

29. A device as claimed in claim 22, characterized in that the mobile device comprises a guide means for guiding an animal subjected to the soaking step to a predetermined place.

30. A device as claimed in claim 29, characterized in that the guide means is provided with a seizing device for seizing an animal.

31. A method of milking a dairy animal, the method comprising the step of stimulating the teats and/or the udder of the dairy animal, characterized in that the stimulation step comprises an application step of applying a stimulation fluid on the teats and/or the udder.

32. A method as claimed in claim 31, characterized in that the step of applying a stimulation fluid comprises the spraying of stimulation fluid.

33. A method as claimed in claim 31 or 32, characterized in that the method comprises an identification step of identifying an animal.

34. A method as claimed in claim 31, 32 or 33, characterized in that the application step is carried out by a mobile device for applying a stimulation fluid, the mobile device being provided with a reservoir for stimulation fluid or with a connection device for connecting a reservoir for stimulation fluid.

35. A method as claimed in any one of the preceding claims 31 through 34, characterized in that the method comprises a checking step of checking whether stimulation fluid has been applied on the teats and/or the udder of an animal.

36. A method as claimed in any one of the preceding claims 31 through 35, characterized in that the application step is carried out in a pre-selection box.

37. A method as claimed in any one of the preceding claims 31 through 36, characterized in that the soaking fluid contains additives for cooling or heating and/or making tingling the teats and/or the udder.

38. A device for milking a dairy animal, said device being provided with a stimulation device for stimulating the teats and/or the udder of the dairy animal, characterized in that the stimulation device comprises an application device for applying a fluid on the teats and/or the udder, the application device being provided with a reservoir for a stimulation fluid or with a connection device for the connection with a reservoir for stimulation fluid.

39. A device as claimed in claim 38, characterized in that the application device comprises a sprayer for spraying a stimulation fluid.

40. A device as claimed in claim 38 or 39, characterized in that the device is provided with an identification system for identifying an animal, the identification system being provided with a computer having a memory.

41. A device as claimed in claim 40, characterized in that the memory is suitable for storing data in relation to the quantities, compositions and concentrations of stimulation fluids in relation to the identity of the relevant animals.

42. A device as claimed in any one of the preceding claims 38 through 41, characterized in that the device is provided with a checking means for checking whether stimulation fluid has been applied on the teats and/or the udder of an animal.

43. A device as claimed in claim 42, characterized in that the checking means comprises a camera.

44. A device as claimed in claim 43, characterized in that the camera is constituted by an infrared camera.

45. A device as claimed in claim 42, 43 or 44, characterized in that the checking means is disposed on a telescopic carrier.

46. A device as claimed in any one of the preceding claims 38 through 45, characterized in that the device is provided in a pre-selection box.

47. A device as claimed in any one of the preceding claims 38 through 46, characterized in that the device is provided with a mobile device for applying a stimulation fluid on the teats and/or the udder.

48. A device as claimed in claim 47, characterized in that the device comprises a transmitting means for transmitting location data of an animal whose teats and/or udder have been provided with stimulation fluid to the mobile device, the mobile device being provided with a receiver device for receiving the location data.

49. A device as claimed in claim 47 or 48, characterized in that the mobile device is provided with a position determining means.

50. A device as claimed in claim 46 or in any one of claims 47 through 49 with reference to claim 46, characterized in that the device is provided with means for at least approximately determining the point of time when an animal leaves the pre-selection box, and for issuing a relevant signal.

51. A device as claimed in claim 50, characterized in that the application device is controlled by the relevant signal.
